(19) United States
(12) Patent Application Publication
(10) Pub. No.: US 2026/0309276 A1
(43) Pub. Date: Oct. 8, 2026

(54) HYDROGEN FUEL STORAGE AND DISTRIBUTION SYSTEMS FOR AIRCRAFT

(71) Applicants: AIRBUS OPERATIONS LIMITED, Bristol (GB); AIRBUS OPERATIONS (SAS), Toulouse Cedex 09 (FR); AIRBUS OPERATIONS GMBH, Hamburg (DE)

(72) Inventors: Christopher PAPADOPOULOS, Bristol (GB); Martin Viktor JOHANSSON, Toulouse Cedex 09 (FR); Thomas HOOGERDIJK, Hamburg (DE)

(21) Appl. No.: 19/640,084

(22) Filed: Apr. 6, 2026

(30) Foreign Application Priority Data
Apr. 8, 2025 (EP) 25300037.6

(51) Int. Cl. F17C 3/08

(52) U.S. Cl. CPC F17C 3/08; F17C 2201/0109; F17C 2203/0304; F17C 2203/0391; F17C 2221/012; F17C 2223/0161; F17C 2250/043; F17C 2250/0626; F17C 2270/0189

(57) ABSTRACT

A system for servicing a vacuum space in a hydrogen storage and distribution system of an aircraft. The vacuum space is an interspace between a vessel and an insulated jacket. A vacuum valve communicates with the vacuum space. The system controls a vacuum pump arrangement using a sensor such as a microphone for sensing the pressure in the interspace to equalise the pressure on the pump side of the valve with the vacuum space before opening the valve.

### RELATED APPLICATION

This application incorporates by reference and claims priority to European patent application EP 25300037.6, filed Apr. 8, 2025.

### FIELD OF THE INVENTION

The invention relates to a hydrogen fuel storage and distribution systems. In particular the invention may be used with a hydrogen fuel storage and distribution system of an aircraft, for example in which the fuel is used for combustion or in a fuel cell reaction to generate propulsive power in a propulsion system of the aircraft.

### BACKGROUND

A system for storage and distribution of liquid cryogenic hydrogen is generally thermally insulated by a vacuum jacket, where it is important to establish and maintain a vacuum in the interspace between a hydrogen vessel, such as a tank or pipe, and the surrounding vacuum jacket without causing damage to equipment including internal equipment.

When drawing a vacuum, it is easy to cause damage to internal equipment if the speed of drawing the vacuum is too high. Likewise, when connecting or disconnecting pump equipment to a vacuum valve of the vacuum space, if the valve is unseated before there is an equalisation of pressure on both sides of the valve then, given the potential level of vacuum inside the interspace, the pressure differential may be sufficient to create a damaging flow. Currently the process of drawing a vacuum is generally a manual process.

The invention aims to address these issues.

### SUMMARY OF THE INVENTION

According to the invention, there is provided a system for servicing a vacuum space in a hydrogen fuel storage and distribution system of an aircraft, the vacuum space having a vacuum valve, comprising: a vacuum pump arrangement having a conduit arranged for fluid connection to the vacuum valve of the vacuum space; at least one sensor for sensing a parameter indicative of pressure in the vacuum space; and a controller arranged to: receive a signal from the sensor; operate the vacuum pump arrangement to lower a pressure in the conduit to a predetermined pressure condition based on the signal; and operate the vacuum valve to open the vacuum valve when the predetermined pressure condition has been reached. Preferably, the controller is then arranged to: operate the vacuum pump arrangement for achieving a vacuum condition in the vacuum space; and operate the vacuum valve to close the vacuum valve when the vacuum condition has been achieved.

Thus the invention may provide an automated system which may provide a pressure balanced (or close to pressure balanced) initial condition before opening a valve, controls the speed by which a two-stage vacuum pump is operated, and/or ensures closing a valve before performing a benign disconnection of the pump from the vacuum valve interface, in order to prevent damage to internal equipment and pump equipment such as ground support equipment. Disconnection may involve slowly raising the pressure in a controlled fashion in order to offer the opportunity to detect leakages, and once it has been confirmed that there are no leakages, allowing the pressure to be raised to ambient to allow disconnection.

By providing equalised initial conditions (or close to equalised initial conditions) before opening the vacuum valve, providing a controlled operation of a pre-vacuum pump to draw down a vacuum in a viscous flow regime so that the flow rate induced does not result in damaging effects to the internal equipment, and safeguarding of the vacuum volume before disconnection, the reliability of the overall vacuum insulation system may be improved.

The predetermined pressure condition maybe a pressure within a predetermined range of a sensed pressure in the vacuum space, such that the pressure is balanced. Preferably, the sensor comprises at least one microphone arranged to sense sound indicative of pressure in the vacuum space.

Operating the pump arrangement may comprise controlling the speed of the vacuum pump arrangement. For example, the pump arrangement may comprise a pre-vacuum pump and a vacuum pump, wherein the pre-vacuum pump is adapted to operate at pressures in the viscous flow region, and the vacuum pump is adapted to operate at pressures in the molecular flow region. The sensor may be arranged to sense whether the pressure in the vacuum space is above a predetermined pressure threshold, and the predetermined threshold may correspond to a pressure sufficient to cause viscous flow.

Thus the controller may be arranged to operate the pump arrangement by: operating only the pre-vacuum pump when the pressure in the vacuum space is above the predetermined threshold; operating the pre-vacuum pump and the vacuum pump when the pressure in the vacuum space is below the predetermined threshold.

When the vacuum valve is opened, the controller may be arranged to operate the pump arrangement dependent upon the predetermined pressure condition, for example by operating only the pre-vacuum pump where the pressure in the vacuum space is above the predetermined pressure; operating the pre-vacuum pump and the vacuum pump where the pressure in the vacuum space is below the predetermined pressure. The pre-vacuum pump and the vacuum pump may be operated simultaneously.

The vacuum space may comprise an interspace between a vessel and an insulation jacket, and the sensor may be provided on the insulation jacket of the vacuum space, or on a wall of the vessel. Providing the sensor on a wall of the vessel, or an inner wall of the vacuum space, may improve isolation from outside sounds, such that sounds caused by the airflow can be easier to hear.

The system may comprise a vessel for containing liquid hydrogen and an insulation jacket at least partially surrounding the vessel, for example wherein the vessel comprises at least one of: a storage tank for storing hydrogen; and a pipe for conveying hydrogen.

The invention also provides an aircraft comprising a system as described.

It will be appreciated that part of the system may be provided on the aircraft, and another part of the system may be provided as servicing equipment for connection to the aircraft. An electrical connection may be provided at or adjacent the fluid connection, for example for facilitating communication between the controller and the sensor and/or vacuum valve. The connection may be a wired connection or may be wireless.

According to another aspect, the invention comprises a method of servicing a vacuum space in a hydrogen fuel storage and distribution system of an aircraft, the vacuum space having a vacuum valve, comprising: connecting a conduit of a vacuum pump arrangement so to be in fluid communication with the valve of the vacuum space; using a sensor to sense a parameter indicative of the pressure in the vacuum space; controlling the pump arrangement to lower the pressure in the conduit based on the sensed parameter to a predetermined condition; controlling the valve to open the valve once the predetermined condition is reached; and controlling the pump arrangement to lower the pressure in the vacuum space.

### BRIEF DESCRIPTION OF THE DRAWINGS

In orders that the invention may be more readily understood, reference will now be made to the accompanying drawings, in which:

FIG. 1 shows a liquid hydrogen (LH2) storage and distribution system;

FIG. 2 is a schematic diagram of a servicing system; and

FIG. 3 is a flow chart of a servicing method.

### DETAILED DESCRIPTION

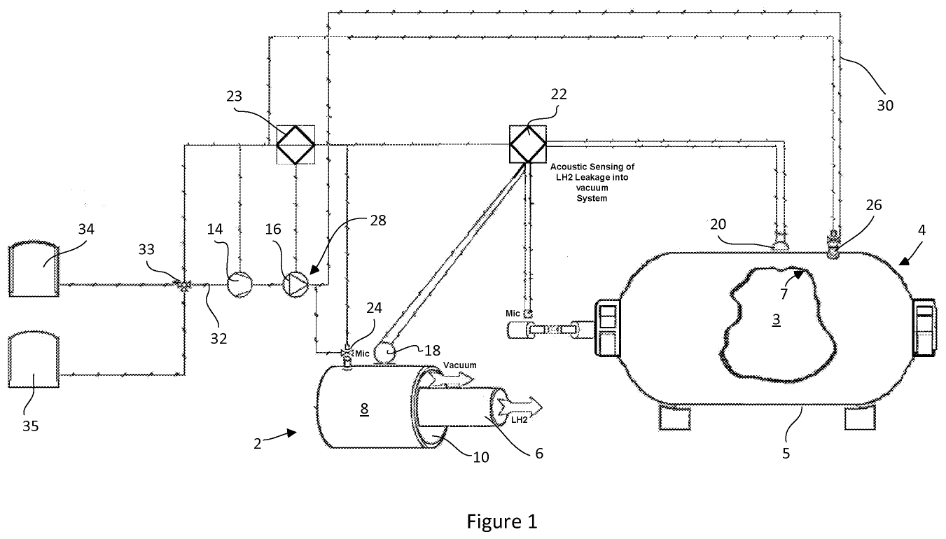

Referring to FIG. 1, a LH2 storage and distribution system comprises a double walled vacuum insulated pipe 2 for carrying LH2, connected to an LH2 storage tank 4, which is similarly insulated with a double walled vacuum insulation arrangement. Referring to the pipe 2, this insulation arrangement comprises an inner containing boundary or vessel wall 6, for example an inner pipe, an outer vacuum jacket 8 and a vacuum interspace 10 between the inner boundary 6 and the outer jacket 8. A similar vacuum interspace 7 is provided between the vessel wall 3 of the tank 4 and a vacuum jacket 5 surrounding the tank.

In the vacuum jacketed arrangement, the inner vessel wall may be constructed for example by welding such that the interspace is able to hold a vacuum. Various equipment may be present within the vacuum jacket arrangement, such as one or more support brackets, a thermal insulation blanket, a hydrogen/oxygen getter and a contaminant adsorber. Various contaminants or debris may also be present, such as glass fibres, aluminium debris or powder, getter material, adsorber material, moisture, air, hydrogen (gaseous/liquefied), nitrogen (gaseous/liquefied/solid), oxygen (gaseous/ liquefied/solid), and other dust.

In such an arrangement there may be leakage of gas into the vacuum interspace, for example if a crack or other breach develops, leading to leakage. There may be at least one sensor which may comprise at least one microphone 18, 20 provided on the or each vacuum jacket arrangement (i.e. one or each of the pipe 2 and the vessel 4), or other acoustic or vibration sensing device. The microphone(s) 18, 20 communicate with an acoustic data processor, 22 for detecting when LH2 or other gas is leaking or has leaked into the vacuum system, and communicate with a programmable logic controller or computer 23.

A pipe vacuum valve 24 is provided for drawing a vacuum in the inner volume or interspace 10 between the inner boundary 6 of the pipe and the outer jacket 8. The valve provides communication between an external controlled volume and the inner volume. Similarly, a tank vacuum valve 26 is provided for drawing a vacuum in the inner volume or interspace 7 between the inner boundary 3 of the tank and the outer jacket 5 is provided.

A two-stage pump arrangement comprises a first pump 14, being a viscous flow pre-vacuum pump, and a second pump 16, being a molecular flow vacuum pump. The first pump 14 provides stepping down of pressure from ambient pressure to a level at which the flow regime starts to change from a viscous flow regime to a molecular flow regime. This is because the molecular flow pump is easily damaged if subjected to viscous flow suddenly. The second pump 16 is protected from such damaging flow by operation of the first pump, and is then operable simultaneously with the first pump to provide a further stepping down of pressure from the end of the viscous flow regime to a significant purely molecular flow regime.

When the pressure is very low, both pumps operating together may improve the vacuum drawdown. When the pressure is higher, for example close to ambient, only the pre-vacuum pump may be needed. Operating the vacuum pump too early risks damaging the vacuum pump. Starting with ambient pressure conditions (i.e. equal to the outside pressure) the pre-vacuum pump may be operated to pump down until the viscous flow regime is nearly at its lower limit, i.e. there are very few molecules left, and then to go further down, the vacuum pump is needed in addition to catch the last few molecules and direct them to the pre-vacuum pump to expel them.

The system is operable to provide a soft start pre-vacuum pump control which aims to prevent interspace equipment damage. Operation of the pump arrangement may be arranged to provide conditions which are as close to equalised as practically possible or as needed dependent upon the equipment present. For example, the equipment may be able to withstand a sudden pressure change within a range which is particular to each item of equipment.

Internal equipment which may be damaged includes:

Thermal Insulation blankets such as multi-layer insulation (MLI) with the possibility to cause the following damage scenarios: tearing of the thin aluminium layers due to aggressive viscous flow; expanding trapped gasses that result in separation of the MLI layers such that a thermally conductive bridge is formed between the outer and inner skins of a vacuum insulation arrangement; stirring up of and accumulation of debris, including from wearing of materials due to chaffing.
Vacuum Valve: movement of debris within a vacuum space resulting in polluting various equipment such as a vacuum valve, clogging the valve, or preventing it from being seating correctly such that it does not fully seal.
Sensors: movement of debris within a vacuum space resulting in polluting the sensors and possibly clogging them thus preventing the sensors from operating correctly.
Getter/Adsorber: movement of debris coating the Getter or Adsorber or any protective filters, thus reducing communication between the vacuum volume and the getter or adsorber, and
Carriers/Spacers: snagging and dislodging any carriers through the movement of any debris or blanket material

In more detail, the microphone sensors 18, 20 provided on the tank and/or pipe wall may be tuned for sound emissions due to at least one of the following (an alternative to the microphone may be a hydrogen sensor and/or a pressure sensor):
Gas entering or exiting the vacuum space
Hydrogen Liquid or Gas entering or exiting the vacuum space
Air entering or exiting the vacuum space
A known inert gas entering or exiting the vacuum space

A change in pressure in the interspace due to the actuated vacuum valve being opened

A drop or increase in pressure in the interspace due to the vacuum pump drawing down or returning to ambient the interspace pressure with the aim of establishing a vacuum or returning to ambient pressure to allow maintenance access to the interspace

The detection algorithm may be tuned to detect differences in the sequence of patterns of sound emissions given the level of vacuum pressure achieved. As an example, if the flow is near ambient pressure, at least one of the following conditions may occur: a. The flow would be primarily viscous and so the frequency of the sounds generated would easily transmit; b. If the flow is too strong, the internal equipment could be heard being affected by the quick drop in pressure and possible expansion of trapped air; c. If the flow is too strong, the internal equipment could be heard releasing trapped air as its expansion creates escape paths from the internal equipment.

The vacuum valve 24, 26 fixed to the outer wall or vacuum jacket of the pipe 2 and tank 4 assembly functions as a pressure containing boundary, and may be opened or closed to allow flow of fluid from inside the interspace 7, 10 to the outside of the valve and to flow from the outside of the valve back into the interspace.

The valve 24, 26 also acts to prevent the flow of fluid in either direction during connection and disconnection of the vacuum pump arrangement, or whilst a vacuum pump arrangement is being used to draw a vacuum on the external side of the valve which is connected to the vacuum pump arrangement to equalise the pressure between the valve outer volume and the vacuum pressure. This is so that on opening the valve there will not be any sudden flow of fluid into the interspace or out of the interspace, as may be the case in the event of a hydrogen leakage. The vacuum valve may have additional functionality, such as a pressure relief function.

The vacuum valve 24, 26 may be operated to open and close by a powered actuator, such as an electrical or pneumatic motor (not shown), or through manual means, such as a lever or knob (not shown). As is well known in the art, the vacuum valve opening mechanism may be such that the amount of opening is tightly controlled to prevent a sudden onrush of a large mass flow rate in the event that there is a leak in the pipework or tank that prevents equalising the inner and outer pressure using the vacuum valve. The vacuum valve also is arranged to prevent static build up under flow conditions so that if hydrogen is being ejected or pumped out, the valve will not pose as an ignition risk.

For example, depending upon the possible pressure difference between the pressure in the vacuum space and the pressure in the conduit, for example due to sensor errors or inaccuracies such as calibration inaccuracies, operating the vacuum valve to open the valve may comprise opening the valve in two stages. The first stage may comprise partially opening the valve to allow equalisation of pressure where there are viscous flow conditions, and the second may comprise fully opening the valve.

The aircraft side 28 of the two-stage pump arrangement is connected by a conduit such as a pipe or tube 30 to each vacuum valve 24, 26 and the downstream side 32 may be connected via a further valve 33 to either a closed cylinder 35 with an inert or noble gas, or to a hydrogen cylinder 34 to offload leaked hydrogen.

The pumps 14, 16 may be used to establish a pressure equilibrium, or near equilibrium, before the vacuum valve 24, 26 is operated to break the vacuum seal. If the pressures are close to equal, the valve plug should be free to move, whereas if there is a significant pressure difference, the valve arrangement can be such that there will be frictional contact of the valve plug, which makes operation difficult. The pumps 14, 16 may then be used to draw out air, inert gas such as nitrogen gas, a noble gas such as helium, or hydrogen, or an oxygen rich mixture with nitrogen as part of establishing a vacuum at the level required for thermal insulation of the hydrogen carrying inner pipe.

For example, a hydrogen source may be due to nominal permeation or leakage due to the inner pipe or inner tank vessel becoming compromised through a joint disassembly, a crack in the wall structure, leakage through any system sensing feed throughs or any other failure mode of a pressure holding boundary.

An air source may be due to the initial storage condition before assembly of the pipe or tank, or due to failures of the outer vacuum jacket wall allowing air to ingress. An oxygen rich mixture with nitrogen may be due to an ingress of air while the inner tank vessel or inner pipe is filled with cryogenic hydrogen causing first oxygen to condense and become more concentrated before the surrounding concentration of oxygen drops enough so that the temperature drops to the liquefaction temperature for nitrogen. An oxygen rich mixture with nitrogen may also be due to warming up from cryogenic conditions, after heating above the boiling point for nitrogen and so removing the nitrogen, when surrounding oxygen will still accumulate through the oxygen continuing to liquefy until the temperature of the volume increases above the oxygen boiling point.

The pumps 14, 16 may be used to decommission the vacuum by letting air or an inert or noble gas into the interspace to allow access for maintenance. The pumps may be used to oscillate the flow to accelerate the extraction of any outgassing contaminants, or any of the other expected gases or of any accumulated debris already mentioned. The pumps may be used to reduce the pressure difference between the external side of the vacuum valve and the ambient as part of the final steps before disconnection of the pumps from the vacuum valve.

The flow rate needed/allowed for which the two stage pumps 14, 16 will be operated or that the valve will be controlled to allow depends on the installation of the equipment internal to the vacuum interspace 7, 10 in relation to the valve plume and flow patterns that are established due to the shape of the interspace and also the specification of the internal equipment and its means of attachment or fixation and also depending on the contents of the vacuum space in the event of an initial commissioning evacuation, or an evacuation following a pressure containing boundary breach, e.g. air has a higher density than hydrogen at similar pressures. Liquefied air also has a higher density than gaseous constituents.

Reference to servicing a vacuum space included drawing a vacuum, maintaining a vacuum, decommissioning a vacuum and regaining a vacuum in the vacuum space.

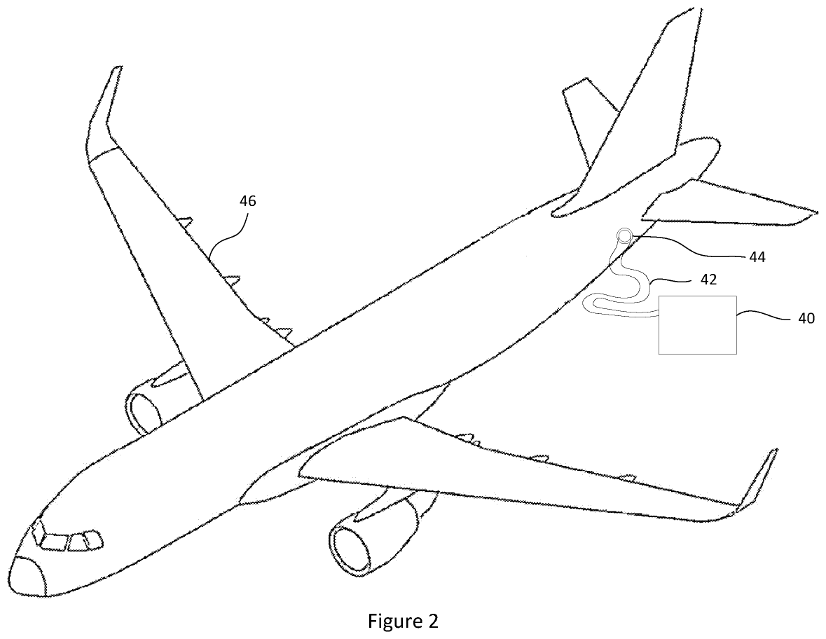

Referring now to FIG. 2, in use of the system, servicing equipment 40, for example a servicing cart, may house the vacuum pump arrangement and the controller, and may have a connector 42 for connection to a servicing port 44 an aircraft 46. The connector 42 may include a fluid connection to the pump arrangement and an electrical connection to the controller. The servicing port 44 may comprise a corresponding fluid connection to a vacuum valve of a vacuum space on the aircraft, and a corresponding electrical connection to a pressure sensor of the vacuum space, as described above.

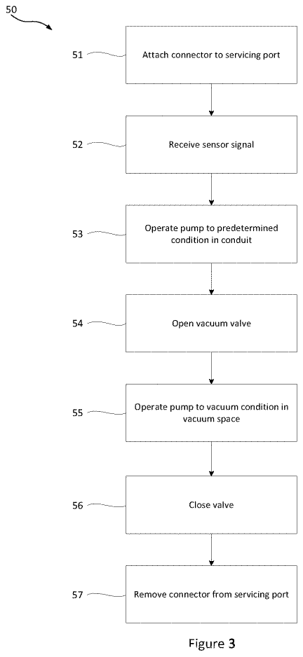

Referring also to FIG. 3 which shows a method 50 of using the servicing equipment 40, the connector 42 of the servicing equipment 40 may be attached to the servicing port 44 of the aircraft 46 at block 51. The equipment 40 may receive a sensor signal indicative of the pressure in the vacuum space via the port 44 at block 52, and the controller may operate the pump arrangement to achieve a predetermined pressure condition in the conduit dependent upon the sensor signal at block 53. Once the predetermined pressure condition in the conduit has been achieved, the controller may then operate the vacuum valve to open the valve at block 54. The pump arrangement may then be operated to achieve a required vacuum condition in the vacuum space at block 55. The vacuum valve may then be closed at block before disconnecting the connector 42 from the servicing port 44 at block 57.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both, unless the disclosure states otherwise. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A system for servicing a vacuum space in a hydrogen fuel storage and distribution system of an aircraft, the vacuum space having a vacuum valve, comprising:
a vacuum pump arrangement having a conduit arranged for fluid connection to the vacuum valve of the vacuum space;
at least one sensor for sensing a parameter indicative of pressure in the vacuum space; and
a controller arranged to:
receive a signal from the sensor;
operate the vacuum pump arrangement to lower a pressure in the conduit to a predetermined pressure condition based on the signal; and
operate the vacuum valve to open the vacuum valve when the predetermined pressure condition has been reached.

2. The system as claimed in claim 1, wherein, after the vacuum valve is open, the controller is arranged to:
operate the vacuum pump arrangement for achieving a vacuum condition in the vacuum space; and
operate the vacuum valve to close the vacuum valve when the vacuum condition has been achieved.

3. The system as claimed in claim 1, wherein the predetermined pressure condition is a pressure within a predetermined range of a sensed pressure in the vacuum space.

4. The system as claimed in claim 1, wherein the sensor comprises at least one microphone arranged to sense sound indicative of pressure in the vacuum space.

5. The system as claimed in claim 1, wherein operating the pump arrangement comprises controlling the speed of the vacuum pump arrangement.

6. The system as claimed in claim 1, wherein the pump arrangement comprises a pre-vacuum pump and a vacuum pump, wherein the pre-vacuum pump is adapted to operate at pressures in the viscous flow region, and the vacuum pump is adapted to operate at pressures in the molecular flow region.

7. The system as claimed in claim 1, wherein the sensor is arranged to sense whether the pressure in the vacuum space is above a predetermined pressure threshold, preferably wherein the predetermined threshold corresponds to a pressure sufficient to cause viscous flow.

8. The system as claimed in claim 7, wherein the controller is arranged to operate the pump arrangement by:
operating only the pre-vacuum pump when the pressure in the vacuum space is above the predetermined threshold;
operating the pre-vacuum pump and the vacuum pump when the pressure in the vacuum space is below the predetermined threshold.

9. The system as claimed in claim 1, wherein, after the vacuum valve is opened, the controller is arranged to operate the vacuum pump arrangement dependent upon the predetermined pressure condition.

10. The system as claimed in claim 9, wherein, after the vacuum valve is opened, operating the vacuum pump arrangement comprises: operating only the pre-vacuum pump where the pressure in the vacuum space is above the predetermined threshold; operating the pre-vacuum pump and the vacuum pump where the pressure in the vacuum space is below the predetermined threshold.

11. The system as claimed in claim 1, wherein the vacuum space comprises an interspace between a vessel and an insulation jacket, preferably wherein the sensor is provided on at least one of: the insulation jacket of the vacuum space, and a wall of the vessel.

12. The system as claimed in claim 1, further comprising a vessel for containing liquid hydrogen and an insulation jacket at least partially surrounding the vessel.

13. The system as claimed in claim 12, wherein the vessel comprises at least one of: a storage tank for storing hydrogen; and a pipe for conveying hydrogen.

14. An aircraft comprising the system as claimed in claim 1.

15. A method of servicing a vacuum space in a hydrogen fuel storage and distribution system of an aircraft, the vacuum space having a vacuum valve, comprising:
connecting a conduit of a vacuum pump arrangement to be in fluid communication with the valve of the vacuum space;
using a sensor to sense a parameter indicative of a pressure in the vacuum space; and
controlling the pump arrangement to lower a pressure in the conduit based on the sensed parameter to a predetermined condition.

16. The method of claim 15, further comprising:
controlling the valve to open the valve once the predetermined condition is reached; and
controlling the pump arrangement to lower the pressure in the vacuum space.
